(19) United States
(12) Patent Application Publication
(10) Pub. No.: US 2026/0170992 A1
(43) Pub. Date: Jun. 18, 2026

(54) Method, Apparatus and System for correcting color, Storage Medium and Electronic Device

(71) Applicants: ANALOGIX (SUZHOU) SEMICONDUCTOR CO., LTD., Suzhou, Jiangsu (CN); ANALOGIX INTERNATIONAL LLC

(72) Inventors: Chialing FENG, Suzhou, Jiangsu (CN); Yuzhi CHEN, Suzhou, Jiangsu (CN)

(21) Appl. No.: 18/579,491

(22) PCT Filed: Aug. 1, 2023
(86) PCT No.: PCT/CN2023/110619

§ 371 Date: Jan. 15, 2024

(30) Foreign Application Priority Data
May 12, 2023 (CN) 202310537835.X

(51) Int. Cl. G09G 3/20; G01J 3/50

(52) U.S. Cl. CPC G09G 3/2092; G01J 3/506; G09G 2320/0242; G09G 2320/0666; G09G 2320/0693; G09G 2370/02

(57) ABSTRACT

Provided are a method, apparatus and system for correcting color, a storage medium and an electronic device. The method for correcting color includes: a first control instruction issued by an upper computer is received and parsed, such that a first parsing result is obtained, where the first control instruction is configured to control a display to output a target image; an internal image generator is enabled, according to the first parsing result, to execute the first control instruction and generate a first image, where the first image corresponds to the target image; and the first image is output to a display panel, and the first image is displayed. introduced

### CROSS-REFERENCE TO RELATED APPLICATION

The disclosure claims the benefit of priority to Chinese Patent Application No. 202310537835.X, filed with the China National Intellectual Property Administration on May 12, 2023 and entitled “Method, apparatus and system for correcting color, storage medium and electronic device”, which is incorporated in its entirety herein by reference.

### TECHNICAL FIELD

The disclosure relates to the technical field of displays, and particularly relates to a method, apparatus and system for correcting color, a computer-readable storage medium and an electronic device.

### BACKGROUND

As a medium tool for connecting users and image data, a display is the most vital input and output device for color management. The display is operated to produce animations, print pictures, retouch pictures during post-production, etc. A wide range of image devices, such as a digital camera, a scanner, a printer, a digital proofer and a display are involved in printing, animation production and later-stage work of professional photography. An image displayed by the display and an image printed will represent different colors if no color data input/output device required by an international color consortium (ICC) profile is used.

In order to avoid the above phenomenon, an external image generator such as Quantum data and Chroma pattern generator is used in the prior art to calibrate the display. However, the external image generator is generally costly and requires a special program to adjust synchronous control of image output and measurement. Alternatively, image control and measurement control are output synchronously through signal output from an upper computer. However, since image output from the upper computer will be affected by an operating system (OS) and a graphics processing unit (GPU), the output is probably not standardly linear, resulting in an inaccurate calibration result.

### SUMMARY

A main objective of the disclosure is to provide a method for correcting color and apparatus, a computer-readable storage medium and an electronic device.

According to an aspect of the disclosure, a method for correcting color is provided. The method includes steps as follows: a first control instruction issued by an upper computer is received and parsed, to obtain a first parsing result, where the first control instruction is configured to control a display to output a target image. An internal image generator of the display is enabled, according to the first parsing result, to execute the first control instruction and generate a first image, where the first image corresponds to the target image. The first image is output to a display panel of the display, and the first image is displayed.

In some embodiments, the method further includes: the upper computer is requested, after the first image is displayed on the display panel, to control an optical measurement instrument to measure first optical data of the display panel.

In some embodiments, the method further includes: a second control instruction issued by the upper computer is received and parsed before the internal image generator outputs the first image, such that a second parsing result is obtained. An image path switcher of the display is enabled, according to the second parsing result, to execute the second control instruction and select a target output path for output of the first image.

In some embodiments, the method further includes: a third control instruction issued by the upper computer is received and parsed before the internal image generator outputs the first image, such that a third parsing result is obtained. A color adjustment control group of the display is enabled, according to the third parsing result, to execute the third control instruction and initialize a parameter of the display.

According to another aspect of the disclosure, an apparatus for correcting color using the above method for correcting color is provided. The apparatus includes: a reception module, configured to receive and parse a first control instruction issued by an upper computer, to obtain a first parsing result, where the first control instruction is configured to control a display to output a target image; a generation module, configured to enable, according to the first parsing result, an internal image generator of the display to execute the first control instruction and generate a first image; and a display module, configured to output the first image to a display panel of the display and display the first image, where the first image corresponds to the target image.

According to yet another aspect of the disclosure, a system for correcting color is provided. The system includes: an upper computer, configured to issue a first control instruction, where the first control instruction is configured to control a display to output a target image; and the above apparatus for correcting color, where a reception module of the apparatus for correcting color is configured to receive and parse the first control instruction issued by the upper computer, such that a first parsing result is obtained; a generation module of the apparatus for correcting color is enabled, according to the first parsing result, to execute the first control instruction and generate a first image; the first image is output to a display module of the apparatus for correcting color, and the first image is displayed, where the first image corresponds to the target image; the reception module includes a register reception/control module; the generation module includes an internal image generator; and the display module includes a display panel.

In some embodiments, the system for correcting color further includes an optical measurement instrument. The optical measurement instrument is configured to measure first optical data of the first image on the display panel after the first image is displayed on the display panel, and provide the first optical data for the upper computer.

In some embodiments, the apparatus for correcting color includes an image path switcher. The image path switcher is configured to request, before the internal image generator outputs the first image, the apparatus for correcting color to receive and parse a second control instruction issued by the upper computer, such that a second parsing result is obtained. The image path switcher is further configured to execute the second control instruction according to the second parsing result and select a target output path for output of the first image.

In some embodiments, the apparatus for correcting color includes a color adjustment control group. The color adjustment control group is configured to request, before the internal image generator outputs the first image, the apparatus for correcting color to receive and parse a third control instruction issued by the upper computer, such that a third parsing result is obtained. The color adjustment control group is further configured to execute the third control instruction according to the third parsing result and initialize a parameter of the display.

According to yet another aspect of the disclosure, a computer-readable storage medium is provided. The computer-readable storage medium includes a stored program. The program controls a device in which the computer-readable storage medium is located to execute the above method for correcting color when running.

According to still another aspect of the disclosure, an electronic device is provided. The electronic device includes: one or more processors; a memory; and one or more programs. The one or more programs are stored in the memory and configured to be executed by the one or more processors, and the one or more programs are configured to execute the above method for correcting color.

### BRIEF DESCRIPTION OF THE DRAWINGS

Accompanying drawings of the description serve as a constituent part of the disclosure to provide a further understanding of the disclosure. Illustrative examples of the disclosure and their descriptions serve to explain the disclosure and are not to be construed as unduly limiting the disclosure. In figures:

FIG. 1 shows a block diagram of hardware structures of a mobile terminal executing a method for correcting color according to an example of the disclosure;

FIG. 2 shows a schematic flow diagram of a method for correcting color according to an example of the disclosure;

FIG. 3 shows a structural block diagram of an apparatus for correcting color according to an example of the disclosure; and

FIG. 4 shows a structural block diagram of a system for correcting color according to an example of the disclosure.

The above figures include reference numerals as follows:

10. reception module, 20. generation module, 30. display module, 40. upper computer, and 50. apparatus for correcting color.

### DETAILED DESCRIPTION OF THE EMBODIMENTS

It should be noted that examples of the disclosure and the features in the examples can be combined with each other without conflict. The disclosure will be described in detail below with reference to accompanying drawings and in combination with examples.

In order to enable those skilled in the art to better understand the solutions of the disclosure, the technical solutions in examples of the disclosure will be described below clearly and comprehensively in combination with accompanying drawings in the examples of the disclosure. Apparently, the examples described are merely some examples rather than all examples. On the basis of examples of the disclosure, all other examples obtained by those of ordinary skill in the art without making creative efforts shall all fall within the scope of protection of the disclosure.

It should be noted that the terms “first”, “second”, etc. in the description and claims of the disclosure and in the above figures are used to distinguish between similar objects and not necessarily to describe a particular order or sequential order. It should be understood that data used in this way can be interchanged where appropriate, so as to conveniently describe examples of the disclosure. In addition, the terms “comprise”, “include”, “have” and their variations are intended to cover non-exclusive inclusions. For instance, a process, method, system, product or device that include a series of steps or units is not required to be limited to those clearly listed steps or units, but can include other steps or units not explicitly listed or inherent to the process, method, product or device.

As introduced in the background art, the external image generator used in the prior art is generally costly and requires a special program to adjust synchronous control of image output and measurement. Alternatively, image control and measurement control are output synchronously through signal output from an upper computer. However, since image output from the upper computer will be affected by an operating system (OS) and a graphics processing unit (GPU), the output is probably not be standardly linear, resulting in an inaccurate calibration result. Therefore, in order to solve the problem of complex color correction framework or inaccurate color correction, examples of the disclosure provide a method, apparatus and system for correcting color, a computer-readable storage medium and an electronic device.

Technical solutions in examples of the disclosure will be clearly and completely described below in combination with accompanying drawings in the examples of the disclosure.

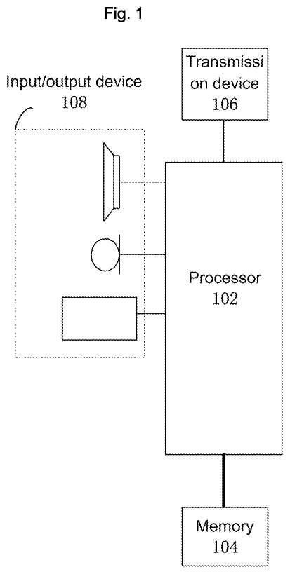

A method example provided in examples of the disclosure can be executed in a mobile terminal, a computer terminal or a similar computation apparatus. In an instance of running on a mobile terminal, FIG. 1 is a block diagram of hardware structures of a mobile terminal executing a method for correcting color according to an example of the disclosure. As shown in FIG. 1, the mobile terminal may include one or more (only one shown in FIG. 1) processors 102 (the processor 102 may include but is not limited to a processing apparatus such as a microcontroller unit (MCU) or a field-programmable gate array (FPGA)) and a memory 104 configured to store data. The above mobile terminal may further include a transmission device 106 for a communication function and an input/output device 108. Those of ordinary skill in the art can understand that the structure shown in FIG. 1 is merely illustrative and does not limit the structure of the above mobile terminal. For instance, the mobile terminal may further include components more or fewer than those shown in FIG. 1, or have a configuration different from that shown in FIG. 1.

The memory 104 may be configured to store a computer program such as a software program and module of application software, specifically such as a computer program corresponding to the method for correcting color in an example of the disclosure. The processor 102 executes various functional applications and data processing by running the computer program stored in the memory 104, that is, implements the above method. The memory 104 may include a high-speed random access memory, and may further include a non-volatile memory such as one or more magnetic storage apparatuses, flash memories, or other non-volatile solid-state memories. In some instances, the memory 104 may further include a memory remotely set with respect to the processor 102, and the remote memory may be connected to the mobile terminal by means of a network. Instances of the above network include but are not limited to the internet, an enterprise intranet, a local area network, a mobile communication network and their combinations. The transmission device 106 is configured to receive or transmit data by means of one network. Specific instances of the above network may include a wireless network provided by a communication provider of the mobile terminal. In an instance, the transmission device 106 includes a network interface controller (NIC), which may be connected to other network devices by means of a base station so as to be in communication with the internet. In an instance, the transmission device 106 may be a radio frequency (RF) module, configured to be in communication with the internet in a wireless manner.

A method for correcting color running on a mobile terminal, a computer terminal or similar computation apparatuses is provided in the example. It should be noted that steps illustrated in a flow diagram of the accompanying drawings can be executed in a computer system such as a set of computer-executable instructions. Moreover, although a logical order is illustrated in the flow diagram, the steps shown or described can be executed in an order different from that herein in some situations.

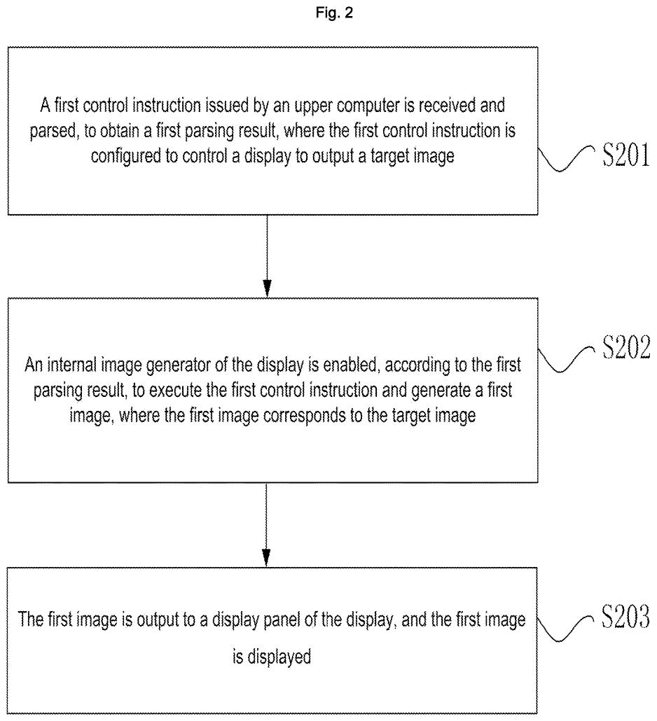

FIG. 2 is a flow diagram of a method for correcting color according to an example of the disclosure. As shown in FIG. 2, the method includes steps as follows:

Step S201: a first control instruction issued by an upper computer is received and parsed, such that a first parsing result is obtained. The first control instruction is configured to control a display to output a target image.

Specifically, the upper computer includes any device that can be configured to output the target image. Exemplarily, the upper computer may include a camera, a plotter, a mobile phone, etc. The display includes any device capable of displaying the target image of the upper computer. Exemplarily, the display may include a mobile phone, a computer, a printer, a notebook computer, a tablet computer, etc.

In some alternative embodiments, the upper computer stores a target image. In order to display the target image in the upper computer on the display, and make an image displayed on the display and the target image consistent with each other at least in color gamut space, after the upper computer is connected to the display, the upper computer can first generate a first control instruction on the basis of the target image, and then issue the first control instruction to the display. After the display receives the first control instruction, the first control instruction is parsed, such that an operation object corresponding to the first control instruction in the display and task content of the operation object are determined. Alternatively, the task content of the operation object includes outputting the target image of the upper computer.

Step S202: an internal image generator of the display is enabled, according to the first parsing result, to execute the first control instruction and generate a first image. The first image corresponds to the target image.

Specifically, after the above first parsing result is obtained, since the first parsing result includes a corresponding operation object and determined task content of the operation object, the display can enable, according to the first parsing result, the operation object to make preparation and perform operation according to the task content in the first parsing result. Alternatively, the operation object includes an internal image generator of the display, and the task content is image data corresponding to the target image of the upper computer, such that the internal image generator generates the first image according to the image data corresponding to the target image of the upper computer.

Step S203: the first image is output to a display panel of the display, and the first image is displayed.

Specifically, in order to display the target image of the upper computer on a display, after being generated, the above first image is directly output to the display panel of the display since the first image corresponds to the target image. Moreover, the first image is displayed on the display panel. Through the example, a first parsing result is obtained by receiving and parsing a first control instruction issued by an upper computer, and on the basis of the first parsing result, an enabling port corresponding to the internal image generator can be set to be opened. Moreover, in a situation that an internal image generator is enabled to execute the first control instruction issued by the upper computer, the internal image generator generates a first image. Further, the generated first image is output to a display panel, and the first image is displayed on the display panel. Therefore, compared with the prior art in which color correction is performed on a display by an external image generator, a color correction framework is simplified. In the prior art, an upper computer is further used for signal output and measurement control when used to output an image, such that image output from the upper computer will be affected by an OS and a graphics processing unit (GPU). Thus, the output image is not standardly linear, and color correction is inaccurate. In the solution, since the first image is generated by the internal image generator of the display, the first image can be directly output on the display panel. Thus, an incorrect image signal introduced by the external image generator is avoided, and a color correction result based on the first image is more accurate.

In order to enable those skilled in the art to understand the technical solution of the disclosure more clearly, an implementation process of the method for correcting color in the disclosure will be described in detail below in combination with particular examples.

In some alternative embodiments, the method for correcting color further includes: the upper computer is requested, after the first image is displayed on the display panel, to control an optical measurement instrument to measure first optical data of the display panel.

In the above embodiment, in order to determine whether the first image displayed on the display panel is consistent with the target image, a measurement step is added to the method for correcting color. Therefore, after the first image is displayed on the display panel, the first optical data of the display panel can be obtained by requesting the upper computer to control the optical measurement instrument to measure the display panel. Since the first optical data is optical data after the first image is displayed on the display panel, the first optical data corresponds to the first image. Moreover, since the first image corresponds to the target image, whether the first image actually displayed on the display is consistent with the target image can be determined according to the first optical data and the target image.

In some alternative embodiments, the optical measurement instrument can provide the measured first optical data for the upper computer, such that in a situation that the upper computer determines that the first image actually displayed by the display is consistent with the target image, the first optical data is stored to be provided for a back-end program for use. Exemplarily, the first optical data may be a chromaticity diagram. The back-end program may include but is not limited to computation of white balance, conversion of a color gamut, and computations of other color correction formulas.

In some alternative embodiments, the method for correcting color further includes: a second control instruction issued by the upper computer is received and parsed before the internal image generator outputs the first image, such that a second parsing result is obtained. An image path switcher of the display is enabled, according to the second parsing result, to execute the second control instruction and select a target output path for output of the first image.

In the above embodiment, since there is an original output path for image output between the upper computer and the display after the upper computer and the display are connected, in order to prevent the target image of the upper computer from being output from the original output path to the display, and display the target image on the display panel, the display can issue a request to the upper computer before the internal image generator in the display outputs the first image. Therefore, the upper computer issues a second control instruction according to the request, and after the display receives and parses the second control instruction, a second parsing result is obtained. The second parsing result can be used to determine and obtain an operation object corresponding to the second control instruction in the display and task content of the operation object. Moreover, the display enables the operation object to make preparation according to the second parsing result and perform operation according to the task content in the second parsing result. Alternatively, the operation object includes an image path switcher of the display. The task content is to switch an image output path of the display, such that the image path switcher closes an original output path for image output and selects a target output path for output of the first image.

In some alternative embodiments, the method for correcting color further includes: a third control instruction issued by the upper computer is received and parsed before the internal image generator outputs the first image, such that a third parsing result is obtained. A color adjustment control group of the display is enabled, according to the third parsing result, to execute the third control instruction and initialize a parameter of the display.

In the above embodiment, since the parameter of the display can be adjusted, the parameter of the display in different time periods may include a plurality of different parameter settings. Exemplarily, the display is calibrated for the first time in order to adapt to a first upper computer, and then is calibrated for the second time in order to adapt to a second upper computer. Resolution of the first upper computer and the second upper computer is different. Therefore, when the display is connected to the first upper computer again, the display parameter of the display does not adapt to the first upper computer any more, such that the output image is inconsistent with the target image. Therefore, in order to enable the display to directly output, in a situation of repeatedly adapting to different upper computers, the first image consistent with the target image without correcting the display parameter for different upper computers, before the internal image generator outputs the first image, the display can issue a request to the upper computer, such that the upper computer issues a third control instruction. The third control instruction is configured to initialize the display parameter. Therefore, after the display receives and parses the third control instruction, a third parsing result is obtained. The third parsing result can be used to determine an operation object corresponding to the third control instruction in the display and determine the task content of the operation object. Moreover, the display enables the operation object to make preparation according to the third parsing result and perform operation according to the task content in the third parsing result. Alternatively, the operation object includes a color adjustment control group of the display. The task content is to initialize a display parameter.

An example of the disclosure further provides an apparatus for correcting color. It should be noted that the apparatus for correcting color in an example of the disclosure can be configured to execute the method for correcting color provided in an example of the disclosure. The apparatus is configured to implement the above examples and preferred embodiments, and repetitions will not be described. The term “module”, as used below, can implement a combination of software and/or hardware having predetermined functions. Although the apparatus described in the following examples is preferably implemented in software, implementation of hardware or a combination of software and hardware is also possible and conceivable.

The apparatus for correcting color provided in an example of the disclosure will be introduced below.

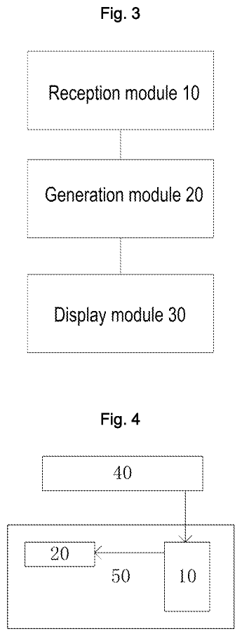

FIG. 3 shows a schematic diagram of an apparatus for correcting color according to an example of the disclosure. As shown in FIG. 3, the apparatus includes: a reception module 10, configured to receive and parse a first control instruction issued by an upper computer, such that a first parsing result is obtained, where the first control instruction is configured to control a display to output a target image; a generation module 20, configured to enable, according to the first parsing result, an internal image generator of the display to execute the first control instruction and generate a first image; and a display module 30, configured to output the first image to a display panel of the display and display the first image, where the first image corresponds to the target image.

In some alternative embodiments, the apparatus for correcting color further includes: a first processing module, configured to request, after the first image is displayed on the display panel, the upper computer to control an optical measurement instrument to measure first optical data of the display panel.

In the above embodiment, in order to determine whether the first image displayed on the display panel is consistent with the target image, a first processing module is added to the apparatus for correcting color. Therefore, after the first image is displayed on the display panel, the first optical data of the display panel can be obtained by requesting the upper computer to control the optical measurement instrument to measure the display panel. Since the first optical data is optical data after the first image is displayed on the display panel, the first optical data corresponds to the first image. Moreover, since the first image corresponds to the target image, whether the first image actually displayed on the display is consistent with the target image can be determined according to the first optical data and the target image.

In some alternative embodiments, the optical measurement instrument can provide the measured first optical data for the upper computer, such that in a situation that the upper computer determines that the first image actually displayed by the display is consistent with the target image, the first optical data is stored to be provided for a back-end program for use. Exemplarily, the back-end program includes but is not limited to computation of white balance, conversion of a color gamut, and computations of other color correction formulas.

In some alternative embodiments, the apparatus for correcting color further includes: a second processing module, configured to receive and parse, before the internal image generator outputs the first image, a second control instruction issued by the upper computer, such that a second parsing result is obtained. The second processing module is further configured to enable, according to the second parsing result, an image path switcher of the display to execute the second control instruction and select a target output path for output of the first image.

In the above embodiment, since there is an original output path for image output between the upper computer and the display after the upper computer and the display are connected, in order to prevent the target image of the upper computer from being output from the original output path to the display, and display the target image on the display panel, the second processing module can issue a request to the upper computer before the internal image generator in the display outputs the first image. Therefore, the upper computer issues a second control instruction according to the request, and after the display receives and parses the second control instruction, a second parsing result is obtained. The second parsing result can be used to determine and obtain an operation object corresponding to the second control instruction in the display and task content of the operation object, and the display enables the operation object to make preparation according to the second parsing result and perform operation according to the task content in the second parsing result. Alternatively, the operation object includes an image path switcher of the display. The task content is to switch an image output path of the display, such that the image path switcher closes an original output path for image output and selects a target output path for output of the first image.

In some alternative embodiments, the apparatus for correcting color further includes: a third processing module, configured to receive and parse, before the internal image generator outputs the first image, a third control instruction issued by the upper computer, such that a third parsing result is obtained. The third processing module is further configured to enable, according to the third parsing result, a color adjustment control group of the display to execute the third control instruction and initialize a parameter of the display.

In the above embodiment, since the parameter of the display can be adjusted, the parameter of the display in different situations may include a plurality of different parameter settings. Exemplarily, the display is calibrated for the first time in order to adapt to a first upper computer, and then is calibrated for the second time in order to adapt to a second upper computer. Resolution of the first upper computer and the second upper computer is different. Therefore, when the display is connected to the first upper computer again, the display parameter of the display does not adapt to the first upper computer any more, such that the output image is inconsistent with the target image. Therefore, in order to enable the display to directly output, in a situation of repeatedly adapting to different upper computers, the first image consistent with the target image without correcting the display parameter for different upper computers, before the internal image generator outputs the first image, the third processing module may issue a request to the upper computer, such that the upper computer issues a third control instruction. The third control instruction is configured to initialize the display parameter. Therefore, after the display receives and parses the third control instruction, a third parsing result is obtained. The third parsing result can be used to determine an operation object corresponding to the third control instruction in the display and determine the task content of the operation object. Moreover, the display enables the operation object to make preparation according to the third parsing result and perform operation according to the task content in the third parsing result.

Alternatively, the operation object includes a color adjustment control group of the display. The task content is to initialize a display parameter. The apparatus for correcting color includes a processor and a memory. The above reception module, generation module and display module are stored in the memory as program units. The processor executes the above program units stored in the memory to implement corresponding functions. The above modules are located in the same processor; or the above modules are separately located in different processors in any combination form.

The processor includes a core, and the core calls corresponding program units in the memory. One or more cores may be arranged, and the problems of complex color correction framework and inaccurate correction result in the prior art can be solved by adjusting parameters of the cores.

The memory may include a volatile memory, a random access memory (RAM) and/or a non-volatile memory, etc., such as a read-only memory (ROM) or a flash RAM, in a computer-readable medium, and the memory includes at least one memory chip.

An example of the disclosure provides a system for correcting color. FIG. 4 shows a structural block diagram of a system for correcting color according to an example of the disclosure. As shown in FIG. 4, the system for correcting color includes: an upper computer 40, configured to issue a first control instruction, where the first control instruction is configured to control a display to output a target image; and the above apparatus for correcting color 50, where a reception module 10 of the apparatus for correcting color 50 is configured to receive and parse the first control instruction issued by the upper computer 40, such that a first parsing result is obtained; a generation module 20 is enabled, according to the first parsing result, to execute the first control instruction and generate a first image; and the first image is output to a display module, and the first image is displayed, where the first image corresponds to the target image. Alternatively, the above reception module 10 may be a register reception/control module. The above generation module 20 may be an internal image generator. The above display module may be a display panel.

In the above example, according to the above system for correcting color in the disclosure, since the first image is generated by the internal image generator (generation module) of the display, the first image can be directly output on the display panel of the display. Therefore, compared with the prior art in which color correction is performed on a display by an external image generator, a color correction framework is simplified. In the prior art, an upper computer is used to output image control and measurement control when used to output an image, such that image output from the upper computer will be affected by an OS and a graphics processing unit (GPU). Thus, the output image is probably not standardly linear, and color correction is inaccurate. Moreover, an incorrect image signal introduced by the external image generator is avoided, and a color correction result based on the first image is more accurate.

Further, in order to determine whether the first image actually displayed by the display is consistent with the target image, the system for correcting color further includes an optical measurement instrument, configured to measure first optical data of the first image on the display panel after the first image is displayed on the display panel, and provide the first optical data for the upper computer. Therefore, since the first optical data is optical data after the first image is displayed on the display panel, the first optical data corresponds to the first image. Moreover, the first image corresponds to the target image such that the upper computer can determine whether the first image actually displayed on the display is consistent with the target image according to the first optical data and the target image.

Further, in order to prevent the target image of the upper computer from being output to the display from the original output path, the apparatus for correcting color includes an image path switcher. The image path switcher is configured to request, before the internal image generator outputs the first image, the apparatus for correcting color to receive and parse a second control instruction issued by the upper computer, such that a second parsing result is obtained. The image path switcher is further configured to execute the second control instruction according to the second parsing result and select a target output path for output of the first image.

Further, in order to enable the display to directly output, in a situation of repeatedly adapting to different upper computers, the first image consistent with the target image without correcting the display parameter for different upper computers, the apparatus for correcting color includes a color adjustment control group. The color adjustment control group is configured to request, before the internal image generator outputs the first image, the apparatus for correcting color to receive and parse a third control instruction issued by the upper computer, such that a third parsing result is obtained. The color adjustment control group is further configured to execute the third control instruction according to the third parsing result and initialize a parameter of the display.

An example of the disclosure provides a computer-readable storage medium. The computer-readable storage medium includes a stored program, where the program controls a device in which the computer-readable storage medium is located to execute the above method for correcting color when running.

Specifically, a method for correcting color includes:

Step S201: a first control instruction issued by an upper computer is received and parsed, such that a first parsing result is obtained. The first control instruction is configured to control a display to output a target image.

Specifically, the upper computer includes any device that can be configured to output the target image. Exemplarily, the upper computer may include a camera, a plotter, a mobile phone, etc. The display includes any device capable of displaying the target image of the upper computer. Exemplarily, the display may include a mobile phone, a computer, a printer, a notebook computer, a tablet computer, etc.

In some alternative embodiments, the target image is first input to the upper computer. In order to display the target image in the upper computer on the display, and make an image displayed on the display and the target image consistent with each other at least in color gamut space, after the upper computer is connected to the display, the upper computer can first generate a first control instruction on the basis of the target image, and then issue the first control instruction to the display. After the display receives the first control instruction, the first control instruction is parsed, such that an operation object corresponding to the first control instruction in the display and task content of the operation object are determined. Alternatively, the task content of the operation object includes outputting the target image of the upper computer. Alternatively, the upper computer may output red-green-blue (RGB) data corresponding to the target image to the display on the basis of an application programming interface (API). Exemplarily, in a situation that a color corresponding to the target image is red, the application programming interface (API) of the upper computer outputs RGB (255, 0, 0). In a situation that a color corresponding to the target image is green, the application programming interface (API) of the upper computer outputs RGB (0, 255, 0). In a situation that a color corresponding to the target image is blue, the application programming interface (API) of the upper computer outputs RGB (0, 0, 255).

Step S202: an internal image generator of the display is enabled, according to the first parsing result, to execute the first control instruction and generate a first image. The first image corresponds to the target image.

Specifically, after the above first parsing result is obtained, since the first parsing result includes a corresponding operation object and determined task content of the operation object, the display can enable, according to the first parsing result, the operation object to make preparation and perform operation according to the task content in the first parsing result. Alternatively, the operation object includes an internal image generator of the display, and the task content is image data corresponding to the target image of the upper computer, such that the internal image generator generates the first image according to the image data corresponding to the target image of the upper computer.

Step S203: the first image is output to a display panel of the display, and the first image is displayed.

Specifically, in order to display the target image of the upper computer on a display, after being generated, the above first image is directly output to the display panel of the display since the first image corresponds to the target image. Moreover, the first image is displayed on the display panel.

Alternatively, the method for correcting color further includes: the upper computer is requested, after the first image is displayed on the display panel, to control an optical measurement instrument to measure first optical data of the display panel.

Alternatively, the method for correcting color further includes: a second control instruction issued by the upper computer is received and parsed before the internal image generator outputs the first image, such that a second parsing result is obtained. An image path switcher of the display is enabled, according to the second parsing result, to execute the second control instruction and select a target output path for output of the first image.

Alternatively, the method for correcting color further includes: a third control instruction issued by the upper computer is received and parsed before the internal image generator outputs the first image, such that a third parsing result is obtained. A color adjustment control group of the display is enabled, according to the third parsing result, to execute the third control instruction and initialize a parameter of the display.

An example of the disclosure provides a device. The device includes a processor, a memory and a program stored in the memory and capable of running on the processor. When the processor executes the program, at least steps as follows are implemented: a first control instruction issued by an upper computer is received and parsed, such that a first parsing result is obtained, where the first control instruction is configured to control a display to output a target image. An internal image generator is enabled, according to the first parsing result, to execute the first control instruction and generate a first image, where the first image corresponds to the target image. The first image is output to a display panel, and the first image is displayed. The device herein may be a server, a personal computer (PC), a PAD, a mobile phone, etc.

Alternatively, the method for correcting color further includes: the upper computer is requested, after the first image is displayed on the display panel, to control an optical measurement instrument to measure first optical data of the display panel.

Alternatively, the method for correcting color further includes: a second control instruction issued by the upper computer is received and parsed before the internal image generator outputs the first image, such that a second parsing result is obtained. An image path switcher of the display is enabled, according to the second parsing result, to execute the second control instruction and select a target output path for output of the first image.

Alternatively, the method for correcting color further includes: a third control instruction issued by the upper computer is received and parsed before the internal image generator outputs the first image, such that a third parsing result is obtained. A color adjustment control group of the display is enabled, according to the third parsing result, to execute the third control instruction and initialize a parameter of the display.

The disclosure further provides a computer program product. When executed on a data processing device, the computer program product is suitable for executing a program initialized with at least method steps as follows: a first control instruction issued by an upper computer is received and parsed, such that a first parsing result is obtained, where the first control instruction is configured to control a display to output a target image. An internal image generator is enabled, according to the first parsing result, to execute the first control instruction and generate a first image, where the first image corresponds to the target image. The first image is output to a display panel, and the first image is displayed.

Alternatively, the method for correcting color further includes: the upper computer is requested, after the first image is displayed on the display panel, to control an optical measurement instrument to measure first optical data of the display panel.

According to the method for correcting color, alternatively, a second control instruction issued by the upper computer is received and parsed before the internal image generator outputs the first image, such that a second parsing result is obtained. An image path switcher of the display is enabled, according to the second parsing result, to execute the second control instruction and select a target output path for output of the first image.

According to the method for correcting color, alternatively, a third control instruction issued by the upper computer is received and parsed before the internal image generator outputs the first image, such that a third parsing result is obtained. A color adjustment control group of the display is enabled, according to the third parsing result, to execute the third control instruction and initialize a parameter of the display.

Obviously, those skilled in the art should understand that all the above modules or steps in the disclosure can be implemented by means of a general-purpose computation apparatus, and can be centralized on a single computation apparatus or distributed on a network composed of a plurality of computation apparatuses. The modules or steps can also be implemented by means of program codes executable by the computation apparatus such that the modules or steps can be stored in a storage apparatus to be executed by the computation apparatus. In some situations, the steps shown or described may be executed in an order different from that herein. Alternatively, the modules or steps are fabricated separately as individual integrated circuit modules, or a plurality of modules or steps are fabricated as a single integrated circuit module to be implemented. Thus, the disclosure is not limited to any particular combination of hardware and software.

Those skilled in the art should understand that examples of the disclosure can be provided as methods, systems, or computer program products. Therefore, the disclosure can employ full hardware examples, full software examples, or software and hardware combined examples. Moreover, the disclosure may employ a form of a computer program product implemented on one or more computer storage medium (including but not limited to a disc memory, a compact disc read-only memory (CD-ROM), an optical memory, etc.) including computer program codes.

The disclosure is described with reference to flow diagrams and/or block diagrams of a method, device (system) and computer program product in examples of the disclosure. It should be understood that each flow and/or block in the flow diagrams and/or block diagrams and combinations of the flows and/or blocks in the flow diagrams and/or block diagrams can be implemented by means of computer program instructions. These computer program instructions can be provided for a processor of a general-purpose computer, a special-purpose computer, an embedded processor, or other programmable data processing devices to produce a machine, such that instructions executed by the processor of the computer or other programmable data processing devices produce an apparatus configured to implement specified functions in one or more flows of each flow diagram and/or one or more blocks of each block diagram.

These computer program instructions can be stored in a computer readable memory that can guide a computer or other programmable data processing devices to work in a specific manner, such that the instructions stored in the computer readable memory produce an article of manufacture including an instruction apparatus. The instruction apparatus implements specified functions in one or more flows of each flow diagram and/or one or more blocks in each block diagram.

These computer program instructions can be loaded onto a computer or other programmable data processing devices, such that a series of operations and steps are executed on the computer or other programmable devices to generate computer-implemented processing. Therefore, the instructions executed on the computer or other programmable devices provide steps for implementing specific functions in one or more flows in each flow diagram and/or one or more blocks in each block diagram.

In a typical configuration, a computing device includes one or more central processing units (CPUs), an input/output interface, a network interface and a memory.

The memory may include a volatile memory, a random access memory (RAM) and/or a non-volatile memory, etc., such as a read-only memory (ROM) or a flash RAM, in a computer-readable medium. The memory is an instance of the computer-readable medium.

The computer-readable medium includes permanent and non-permanent as well as movable and non-movable media and can storage information by means of any method or technology. The information can be modules of computer-readable instructions, data structures and programs, or other data. Instances of the computer storage medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, a magnetic tape or magnetic disk storage or other magnetic storage devices, or any other non-transmission media that can be configured to store information capable of being accessed by a computing device. As defined herein, the computer-readable media do not include transitory media, such as modulated data signals and carrier waves.

It should be noted that the terms “comprise”, “include” or their variations are intended to cover non-exclusive inclusions, such that a process, method, commodity or device including a series of elements not only includes those elements, but also includes other elements that are not explicitly listed, or also includes inherent elements of the process, method, commodity or device. Without more limitations, the elements defined by the sentence “comprise a” and “include a . . . ” do not exclude the existence of other identical elements in the process, method, commodity or device including the elements.

From the above description, it can be seen that the above examples of the disclosure achieve technical effects as follows:
a first parsing result is obtained by receiving and parsing a first control instruction issued by an upper computer, and on the basis of the first parsing result, an enabling port corresponding to the internal image generator can be set to be opened. Moreover, in a situation that an internal image generator is enabled to execute the first control instruction issued by the upper computer, the internal image generator generates a first image. Further, the generated first image is output to a display panel of a display, and the first image is displayed on the display panel. Therefore, compared with the prior art in which color correction is performed on a display by an external image generator, a color correction framework is simplified. In the prior art, an upper computer is further used for signal output and measurement control when used to output an image, such that image output from the upper computer will be affected by an OS and a graphics processing unit (GPU). Thus, the output image is not standardly linear, and color correction is inaccurate. In the solution, since the first image is generated by the internal image generator of the display, the first image can be directly output on the display panel. Thus, an incorrect image signal introduced by the external image generator is avoided, and a color correction result based on the first image is more accurate.

The above examples are merely preferred examples of the disclosure and are not intended to limit the disclosure. Various changes and modifications can be made on the disclosure by those skilled in the art. Any modifications, equivalent substitutions, improvements, etc. within the spirit and principles of the disclosure are intended to be included within the scope of protection of the disclosure.

1. A method for correcting method for correcting color, comprising:
receiving and parsing a first control instruction issued by an upper computer, to obtain a first parsing result, wherein the first control instruction is configured to control a display to output a target image;
enabling, according to the first parsing result, an internal image generator of the display to execute the first control instruction and generate a first image, wherein the first image corresponds to the target image; and
outputting the first image to a display panel of the display, and displaying the first image.

2. The method for correcting color according to claim 1, further comprising:
requesting, after the first image is displayed on the display panel, the upper computer to control an optical measurement instrument to measure first optical data of the display panel.

3. The method for correcting color according to claim 1, further comprising:
receiving and parsing, before the internal image generator outputs the first image, a second control instruction issued by the upper computer, such that a second parsing result is obtained; and
enabling, according to the second parsing result, an image path switcher of the display to execute the second control instruction and select a target output path for output of the first image.

4. The method for correcting color according to claim 1, further comprising:
receiving and parsing, before the internal image generator outputs the first image, a third control instruction issued by the upper computer, such that a third parsing result is obtained; and
enabling, according to the third parsing result, a color adjustment control group of the display to execute the third control instruction and initialize a parameter of the display.

5. (canceled)

6. A system for correcting color, comprising:
an upper computer, configured to issue a first control instruction, wherein the first control instruction is configured to control a display to output a target image; and
the apparatus for correcting color, wherein a reception module of the apparatus for correcting color is configured to receive and parse the first control instruction issued by the upper computer, such that a first parsing result is obtained; a generation module of the apparatus for correcting color is enabled, according to the first parsing result, to execute the first control instruction and generate a first image, wherein the first image corresponds to the target image; the first image is output to a display module of the apparatus for correcting color, and the first image is displayed; the reception module comprises a register reception/control module; the generation module comprises an internal image generator; and the display module comprises a display panel.

7. The system for correcting color according to claim 6, further comprising an optical measurement instrument, configured to measure first optical data of the first image on the display panel after the first image is displayed on the display panel, and provide the first optical data for the upper computer.

8. The system for correcting color according to claim 6, wherein the apparatus for correcting color comprises an image path switcher; the image path switcher is configured to request, before the internal image generator outputs the first image, the apparatus for correcting color to receive and parse a second control instruction issued by the upper computer, such that a second parsing result is obtained; and the image path switcher is further configured to execute the second control instruction according to the second parsing result and select a target output path for output of the first image.

9. The system for correcting color according to claim 6, wherein the apparatus for correcting color comprises a color adjustment control group; the color adjustment control group is configured to request, before the internal image generator outputs the first image, the apparatus for correcting color to receive and parse a third control instruction issued by the upper computer, such that a third parsing result is obtained; and the color adjustment control group is further configured to execute the third control instruction according to the third parsing result and initialize a parameter of the display.

10. A non-transitory computer-readable storage medium, comprising a stored program, wherein the program when running controls a device in which the computer-readable storage medium is located to:
receive and parse a first control instruction issued by an upper computer, such that a first parsing result is obtained, wherein the first control instruction is configured to control a display to output a target image;
enable, according to the first parsing result, an internal image generator of the display to execute the first control instruction and generate a first image, wherein the first image corresponds to the target image; and
output the first image to a display panel of the display, and display the first image.

11. (canceled)

12. The method for correcting color according to claim 2, further comprising:
receiving and parsing, before the internal image generator outputs the first image, a second control instruction issued by the upper computer, such that a second parsing result is obtained; and
enabling, according to the second parsing result, an image path switcher of the display to execute the second control instruction and select a target output path for output of the first image.

13. The method for correcting color according to claim 2, further comprising:
receiving and parsing, before the internal image generator outputs the first image, a third control instruction issued by the upper computer, such that a third parsing result is obtained; and
enabling, according to the third parsing result, a color adjustment control group of the display to execute the third control instruction and initialize a parameter of the display.

14. The system for correcting color according to claim 7, wherein the apparatus for correcting color comprises an image path switcher; the image path switcher is configured to request, before the internal image generator outputs the first image, the apparatus for correcting color to receive and parse a second control instruction issued by the upper computer, such that a second parsing result is obtained; and the image path switcher is further configured to execute the second control instruction according to the second parsing result and select a target output path for output of the first image.

15. The system for correcting color according to claim 7, wherein the apparatus for correcting color comprises a color adjustment control group; the color adjustment control group is configured to request, before the internal image generator outputs the first image, the apparatus for correcting color to receive and parse a third control instruction issued by the upper computer, such that a third parsing result is obtained; and the color adjustment control group is further configured to execute the third control instruction according to the third parsing result and initialize a parameter of the display.

16. The computer-readable storage medium according to claim 10, wherein the program when running controls the device further to:
request, after the first image is displayed on the display panel, the upper computer to control an optical measurement instrument to measure first optical data of the display panel.

17. The computer-readable storage medium according to claim 10, wherein the program when running controls the device further to:
receive and parse, before the internal image generator outputs the first image, a second control instruction issued by the upper computer, such that a second parsing result is obtained; and
enable, according to the second parsing result, an image path switcher of the display to execute the second control instruction and select a target output path for output of the first image.

18. The computer-readable storage medium according to claim 10, wherein the program when running controls the device further to:
receive and parse, before the internal image generator outputs the first image, a third control instruction issued by the upper computer, such that a third parsing result is obtained; and
enable, according to the third parsing result, a color adjustment control group of the display to execute the third control instruction and initialize a parameter of the display.
